(19) United States
(12) Patent Application Publication
(10) Pub. No.: US 2023/0099523 A1
(43) Pub. Date: Mar. 30, 2023

(54) AGRICULTURAL PRODUCTION MACHINE WITH CHARACTERISTIC DIAGRAM CONTROL

(71) Applicant: CLAAS Selbstfahrende Erntemaschinen GmbH, Harsewinkel (DE)

(72) Inventors: Joachim Baumgarten, Beelen (DE); Andreas Wilken, Bissendorf (DE); Dennis Neitemeier, Lippetal (DE); Bastian Bormann, Gütersloh (DE); Sebastian Spiekermann, Ostbevern (DE); Daniel Irmer, Herzebrock-Clarholz (DE)

(73) Assignee: CLAAS Selbstfahrende Erntemaschinen GmbH, Harsewinkel (DE)

(21) Appl. No.: 17/953,794

(22) Filed: Sep. 27, 2022

(30) Foreign Application Priority Data
Sep. 28, 2021 (DE) 10 2021 125 124.9

(51) Int. Cl. A01D 41/127

(52) U.S. Cl. CPC A01D 41/1273; A01D 41/1276; A01D 41/1277

(57) ABSTRACT

An agricultural production machine comprising a characteristic diagram control is disclosed. The characteristic diagram control comprises one or more characteristic diagrams. Each characteristic diagram is configured to optimize operating parameters of the process units of the agricultural production machine. The particular characteristic diagram is designed as an initial characteristic diagram. In the initial characteristic diagram, at least the relationship between operating parameters of a process unit and quality parameters is described by initial operating points. A control characteristic curve is associated with the particular characteristic diagram, and the control characteristic curve lies around the minimum or maximum of the particular quality parameter.

### REFERENCE TO RELATED APPLICATIONS

This application claims priority under 35 U.S.C. § 119 to German Patent Application No. 10 2021 125 124.9 filed Sep. 28, 2021, the entire disclosure of which is hereby incorporated by reference herein. The application is related to US Application No. ______ (attorney docket no. 15191-22022A (P05507/8)) and US Application No. ______ (attorney docket no. 15191-22023A (P05474/8)), both of which incorporated by reference herein in their entirety.

### TECHNICAL FIELD

The invention relates to an agricultural production machine comprising a characteristic diagram control.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Control of agricultural production machines may be performed based on characteristic diagrams. A characteristic diagram control system is disclosed in US Patent No. 9,002,594, incorporated by reference in its entirety, the characteristic diagram of which may be updated at regular intervals by specifically moving to operating points that lie outside the characteristic diagram range being run through.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 illustrates a combine with a harvesting header that is only partially depicted.

FIGS. 2A-B illustrate a detailed view of the combine and the harvesting header according to FIG. 1.

FIG. 3 illustrates a schematic representation of the characteristic diagram control.

FIG. 4A illustrates a detailed representation of the characteristic diagram adaptation.

FIG. 4B illustrates detailed explanations of FIG. 4A.

FIG. 5 illustrates a schematic representation of the operation of the driver assistance system.

FIGS. 6A-E are example applications of characteristic diagram adaptation to special characteristic diagrams.

### DETAILED DESCRIPTION

As discussed in the background, control of agricultural production machines may be performed based on characteristic diagrams. Since characteristic diagrams may comprise (or consist of) a large number of characteristic curves and these may follow certain mathematical relationships, these characteristic curves may always describe the dependencies between influencing and evaluation variables relatively well only in the operating range being run through, while the curves outside these ranges may often no longer reflect the real relationships with sufficient accuracy. If a current operating point is reached that does not lie in this currently traversed characteristic diagram range, influencing variables are determined that do not lie in an optimized range. This may lead a process, such as an optimization process, that may only gradually lead to optimal values of the influencing variables, such as grain loss. During this time, the optimization function of the driver assistance system may not work optimally. The method disclosed in U.S. Pat. No. 9,002,594 at least partially overcomes these known disadvantages, but may itself have the disadvantage that the targeted approach to certain operating points makes the optimization process more complicated for the operator of the agricultural production machine, since he/she may need to actively trigger and control an update of the stored characteristic diagram.

Characteristic diagram-based control of agricultural harvesters is described in U.S. Pat. Nos. 9,807,926, 10,231,380, 9,220,196, each of which are incorporated by reference herein in its entirety. In particular, characteristic diagram-based control of agricultural harvesters is gaining in importance. As such, there may be a need to simplify and accelerate the updating of the particular characteristic diagrams.

In this context, driver assistance systems may be used that control operation, such as the optimization of the operation, of the process units of the agricultural working machine using so-called automated units, such as disclosed in U.S. Pat. No. 11,304,369 (incorporated by reference herein in its entirety) or EP 3 123 711 A1.

Thus, in one or some embodiments, a system is disclosed to avoid the described disadvantages of the prior art and, in particular, a device is disclosed for updating working unit parameter-optimizing characteristic diagrams which may simplify and/or accelerate the updating of characteristic diagrams.

In one or some embodiments, this may be accomplished by an agricultural production machine that comprises a characteristic diagram control (such as a characteristic diagram control device) and the characteristic diagram control (such as a characteristic diagram control device) considering one or more characteristic diagrams. In one or some embodiments, one, some or each of the one or more characteristic diagrams may be configured to control (such as to optimize) operating parameters of the process units of the agricultural production machine. More specifically, a particular or respective characteristic diagram (e.g., of the one or more characteristic diagrams) may be designed as an initial characteristic diagram, and in the initial characteristic diagram, at least the relationship between operating parameters of a process unit and quality parameters may be described by initial operating points and a control characteristic curve is associated with the particular characteristic diagram. The control characteristic curve may be positioned or situated dependent on or relative to one or both of the minimum or maximum of the particular quality parameter (e.g., the control characteristic curve may lie around the minimum or maximum of the particular quality parameter). This may result in the updating of characteristic diagrams to be simplified and accelerated since the optimization process may be guided along the determined control characteristic curve.

The characteristic diagram (e.g., prior to or after updating the initial characteristic diagram) may be used by the agricultural production machine (such as a controller of the agricultural production machine) in order to select one or more parameters (e.g., any parameters described herein, such as one or more operating parameters, such as one or more optimized operating parameters). In turn, the one or more parameters may be used in order to control at least one aspect of the agricultural production machine. By way of example, one or more process units of the agricultural production machine may receive the one or more parameters, and, responsive to receiving the one or more parameters, may automatically control itself (e.g., modify its operation) based on the one or more parameters received. In this way, the updating of the characteristic diagram may be used to control operation of at least a part of the agricultural production machine.

In one or some embodiments, instantaneous operating points may be determined in working mode (e.g., when the agricultural harvesting machine is working as a combine or the like) as a function of measurands, with the instantaneous operating points being converted into quasi-stationary operating points. The determined quasi-stationary operating points may supplement or overwrite the initial operating points or the already updated operating points of the particular characteristic diagram. In turn, the initial characteristic diagram may be converted into an updated characteristic diagram (e.g., based on the determined quasi-stationary operating points), thereby determining an updated control characteristic curve of the updated characteristic diagram. This may be result in the characteristic diagram being updated directly in the harvesting operation using simple calculation methods (e.g., without having to specifically approach special operating points for this purpose).

In one or some embodiments, optimized operating parameters may be determined using the updated control characteristic curve, and the particular optimized operating parameters may be specified to the particular process unit. Given that the characteristic diagrams may describe parameter correlations in a large spatial value range in this case, a simple method may be created using the control characteristic curve, which may lie or be situated around the minimum or maximum of the particular quality parameter. Such a method may quickly lead to optimized operating parameters.

In one or some embodiments, the determined instantaneous operating points may be stored in a first data matrix. Further, the change in the value of the particular instantaneous operating point may be determined within a time interval, and the instantaneous operating point may then be converted into a quasi-stationary operating point if its value remains approximately unchanged (e.g., constant). In this way, it may be ensured that the operating points to be transferred to the particular characteristic diagram are of sufficient quality and therefore have few errors. Furthermore, it may be ensured that quasi-stationary points, which may be obsolete and no longer reflect the current situation, are discarded.

In one or some embodiments, the determined quasi-stationary operating points may be collected in a further data matrix. Further, a certain number of quasi-stationary operating points may be collected in the further data matrix, such as four quasi-stationary operating points (or another predetermined number), and at least the dependencies between a quality parameter and an operating parameter may be determined in the further data matrix for the collected quasi-stationary operating points analogous to the particular initial characteristic diagram. This may especially have the effect that the particular characteristic diagram is not updated permanently or constantly, but at acceptable intervals (e.g., at predetermined intervals or responsive to predetermined triggers), such as when operating parameters change significantly, so that the available computing power may also be used efficiently.

In one or some embodiments, the quasi-stationary operating points collected in the further data matrix may be transferred to an initial data matrix. Further, the initial data matrix may correspond to the initial characteristic diagram with the transferred quasi-stationary operating points so that the updating of the actual characteristic diagram may be calculated in an intermediate database without this having any influence on the characteristic diagram according to which the agricultural production machine is optimized during ongoing operation. In this context, it may therefore also be advantageous if the updated characteristic diagram is then calculated from the initial data matrix in a characteristic diagram update step, wherein the updated characteristic diagram may replace the initial characteristic diagram or a previously updated characteristic diagram, and wherein the control characteristic may be recalculated for each updated characteristic diagram in a “control characteristic update” step. This may have, in particular, the effect that the characteristic diagram and control characteristic update of the characteristic diagram, according to which the agricultural production machine may be controlled, may be updated in one step and in a very short period of time.

In one or some embodiments, a particularly effective driver assistance system may be achieved when the characteristic diagram control is integrated into a driver assistance system associated with the agricultural production machine. The characteristic diagrams may be stored in a memory of the driver assistance system, and a computing device may be configured to operate the characteristic diagram control (such as the characteristic diagram control device) using the characteristic diagrams stored in the memory of the driver assistance system. The driver assistance system may further be configured to perform any one, any combination, or all of: a. determine the measurands; b. derive at least the instantaneous operating points from the determined measurands; c. convert the instantaneous operating point into the quasi-stationary operating point; d. transfer the quasi-stationary operating point to the particular stored initial characteristic diagram or the already-updated characteristic diagram; e. replace an initial operating point or an already-updated operating point in the particular characteristic diagram with a quasi-stationary operating point; f. while take into account the inserted quasi-stationary operating points, calculate an updated characteristic diagram; g. determine the control characteristic of the updated characteristic diagram; h. determine optimized operating parameters using the updated control characteristic curve; i. specify the particular optimized operating parameter to the particular process unit.

In one or some embodiments, the initial characteristic diagram may be stored in a start configuration in the driver assistance system of the agricultural production machine. Alternatively, the initial characteristic diagram may be transferred to the driver assistance system before a working mode. The initial characteristic diagram may be updated cyclically during the working mode and may be stored as a new initial characteristic diagram.

In one or some embodiments, the agricultural production machine may be designed as an agricultural harvesting machine. Further, the working mode may be a harvesting mode (e.g., the combine is currently harvesting). In such an instance, the working quality of a harvesting machine in the harvesting mode may be significantly improved.

In one or some embodiments, the measurand(s) may comprise any one, any combination, or all of: the longitudinal vibration; the transverse vibration of a flow of harvested material passing through the agricultural harvesting machine; the crop height; or the hydraulic pressure or power requirement of a reel drive motor. Further, the measurands may be converted into quality parameters or a harvested material throughput, so that some or all boundary conditions which significantly influence the quality of work of the agricultural production machine may be comprehensively considered.

In one or some embodiments, a particularly efficient optimization process for the mode of operation of the agricultural harvesting machine may result when one or more process units together with the driver assistance system form an automated process unit (with the characteristic diagrams stored in the memory of the driver assistance system). The computing device may be configured to operate the automated process unit as a characteristic diagram control (such as a characteristic diagram control device) using the stored characteristic diagrams. Further, the automated process unit may be configured to optimize operating parameters of the process unit or units, and to specify the optimized operating parameters to the particular process unit. In this context, it may be advantageous if the automated process unit is designed as any one, any combination, or all of: an automated attachment; an automated draper; an automated threshing unit; an automated separating unit; an automated cleaning unit; an automated chopping unit; or an automated distributing unit. In one or some embodiments, each of the automated process units may form automated subunits, wherein each of the automated subunits may be configured to optimize operating parameters of a process unit and to specify the optimized operating parameters to the particular process unit. In this way, a comprehensive optimization of the working quality of the agricultural production machine may be ensured.

In one or some embodiments, the one or more characteristic diagrams assigned to the particular automated process unit or the particular automated subunit may describe the relationship between the operating parameters of a process unit and quality parameters, and may ensure that the influence of each individual process unit on the material flow optimization in the agricultural harvesting machine may be controlled in a targeted manner.

In one or some embodiments, the most significant influence on the movement of a flow of harvested material through an agricultural harvesting machine is the harvested material throughput. As such, very high or very low harvested material throughputs may cause disturbances in the flow of harvested material within the harvesting header and the agricultural harvesting machine. It may therefore be very advantageous if the particular characteristic diagram takes into account a parameter representing the harvested material throughput, such as the layer height.

In one or some embodiments, the quality parameter or parameters of the one or more characteristic diagrams are a vibration coefficient and/or a separation loss. Further, the vibration coefficient may be an indicator of the layer height variations and thus of an inhomogeneous material flow. Alternatively, or in addition, the separation loss may be an essential parameter describing the working quality of a combine. Further, increasing separation losses may also be an indication of a non-optimal material flow of the flow of harvested material through the combine.

In one or some embodiments, since the vibration coefficient may describe a fluctuation of the harvested material throughput, and means may be provided which may determine a harvested material throughput and the vibration coefficient describing the fluctuation of the harvested material throughput in a region lying in front of the threshing elements of the agricultural harvesting machine, it may be ensured that the parameter most clearly describing an inhomogeneous harvested material flow may decisively be taken into account in the optimization of the harvested material flow in the harvesting header. Moreover, since the vibration coefficient may also be determined in a region located upstream from the threshing units, the influence of the threshing units, which may completely alter the harvested material flow structure, may be excluded.

In one or some embodiments, the particular characteristic diagram may therefore describe the particular operating parameter as a function of the vibration coefficient and the layer height representing the harvested material throughput. In this context, it may therefore also be advantageous if the particular characteristic diagram describes the particular operating parameter or parameters to be optimized at least as a function of the separation loss.

In one or some embodiments, the characteristic diagram may describe the relationship between the quality parameter vibration coefficient, the parameter layer height representing the harvested material throughput, and an operating parameter. Further, the control characteristic curve assigned to the characteristic diagram may lie around the minimum vibration coefficient (123).

In one or some embodiments, efficient characteristic diagram control is achieved when the characteristic diagram describes the relationship between the quality parameter “vibration coefficient”, the parameter “layer height” representing the harvested material throughput, and an operating parameter, and the control characteristic curve assigned to the characteristic diagram lies around the minimum vibration coefficient.

In one or some embodiments, efficient characteristic diagram control also results when the automated process unit is designed as an automated draper, and the characteristic diagram takes into account the relationship between the quality parameter “vibration coefficient”, the parameter “layer height” representing the harvested material throughput and the operating parameter “belt speed of the middle belt” or the operating parameter “belt speed of the right side and/or left side transverse conveyor belt” or the operating parameter “reel height”, or the operating parameter “reel horizontal position and/or reel vertical position”, and the control characteristic associated with the characteristic diagram may lie around the minimum of the vibration coefficient.

In one or some embodiments, the one or more characteristic diagrams are such that they describe the relationship between operating parameters of a process unit and quality parameters. In this context, it may be advantageous if one or more characteristic diagrams are assigned to each automated subunit. Further, the one or more characteristic diagrams may describe at least the relationship between operating parameters of the process unit assigned to the particular automated subunit and quality parameters. In this way, it may be possible to control each process unit of the draper very specifically, since experience has shown that the individual process units have a very different influence on the material flow in the draper.

In one or some embodiments, given that a non-optimal flow of harvested material in the harvesting header and the agricultural harvesting machine also may have negative effects on the separation loss, the characteristic diagram may describe the relationship between the quality parameter “separation loss” and one or more operating parameters. Further, the control characteristic associated with the characteristic diagram may lie around the minimum of the separation loss. In this context, it may also be advantageous if the automated process unit is designed as an automated draper if the characteristic diagram describes the relationship between the quality parameter separation loss, the parameter hydraulic pressure or power requirement of a reel drive motor/reel drive cylinder representing the harvested material throughput and the operating parameter reel horizontal position and/or reel vertical position, and the control characteristic curve assigned to the characteristic diagram lies around the minimum of the separation loss.

In one or some embodiments, one or more operating parameters of an agricultural harvester may be improved, such as optimized, based on the characteristic diagram adaptation, thereby improving the working quality of the agricultural harvester. Therefore, in one or some embodiments, the operating parameters to be optimized may include the operating parameters of any one, any combination, or all of: cutting speed; cutter stroke; belt speed; feed roller horizontal position; feed roller speed; reel vertical position; reel horizontal position; threshing drum speed; size of threshing gap; deflection roller speed; rotor speed; vibration frequency and vibration direction of the sieve planes; fan speed; speed of the straw chopper; speed of the distribution device, and discharge point of the distribution device.

In one or some embodiments, the adaptation of the particular characteristic diagram as a function of the vibration coefficient may cause a fast, dynamic adaptation (e.g., faster adaptation) of the particular characteristic diagram, while the adaptation of the particular characteristic diagram as a function of the separation loss may cause a slow, sluggish adaptation (e.g., slower adaptation) of the particular characteristic diagram. Further, it may be ensured that the influence of both short-term and long-term effects is considered when improving or optimizing the operating parameters of the draper.

In one or some embodiments, in order to sufficiently consider the influence of short-term and long-term effects on the optimization of an operating parameter, it is provided that the adaptation of the characteristic diagram comprises a superposition (e.g., superimposition) of a dynamic characteristic diagram adaptation “vibration coefficient,” and an inertial characteristic diagram adaptation “separation loss”.

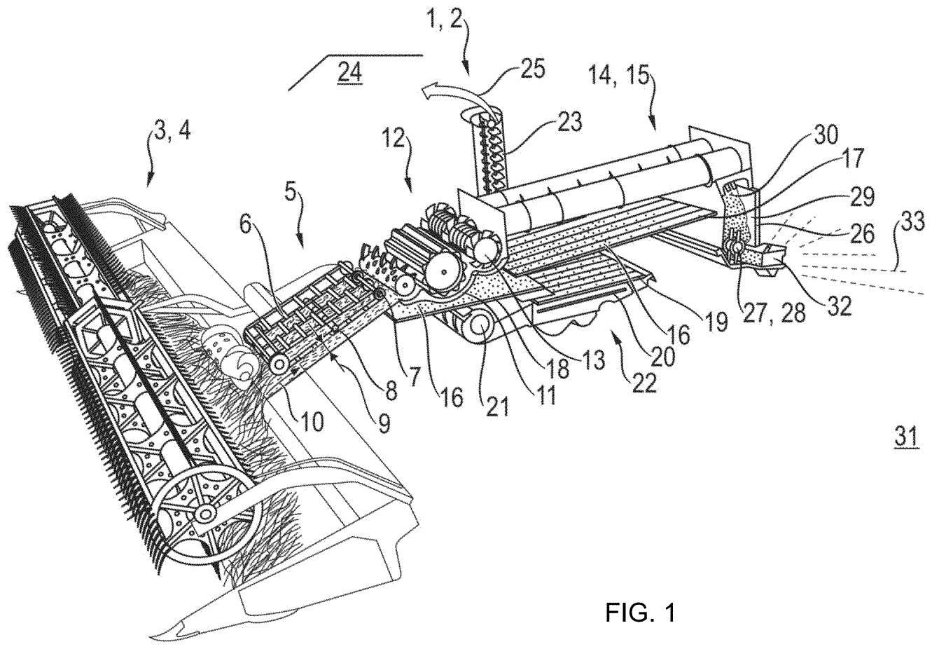

Referring to the figures, the agricultural production machine 1 shown schematically in FIG. 1, designed as a combine 2, may accommodate in its front area a harvesting header 3 designed for example as a draper 4, which may be connected, in a manner known to one of skill in the art, to the inclined conveyor 5 of the combine 2. The conveying elements 6 of the inclined conveyor 5 may be guided on the upper side so as to be pivotable about a pivot axis 7 transversely to the longitudinal direction of the combine 2. In the depicted embodiment, a so-called layer height roller 8, which is explained in more detail later, is associated with the conveying elements 6 in a central region, the deflection of which roller in the vertical direction is a measure of the layer height 9 of the flow of harvested material 10 passing through the inclined conveyor 5. The flow of harvested material 10 passing through the inclined conveyor 5 may be transferred in the upper rear region of the inclined conveyor 5 to the threshing units 12 of the combine 2, which may at least partially be surrounded by a so-called threshing concave 11 on the bottom. A deflection roller 13 downstream from the threshing units 12 may divert the flow of harvested material 10 out of the threshing units 12 in their rearward area so that the flow is immediately transferred to a separating device 15, which may be designed as a separating rotor assembly 14. In one or some embodiments, the separating device 15 may also be designed as a known (and therefore not shown) straw walker. It is also contemplated that the separating device may be designed only with a single-rotor, or the threshing units 12 and the separating device 15 may be combined to form a single- or double-rotor axial flow threshing and separating device.

In the separating device 15, the flow of harvested material 10 may be conveyed in such a way that free-moving grains 16 contained in the flow of harvested material 10 are separated in the downstream region of the separating device 15. The grains 16 deposited both on the threshing concave 11 as well as in the separating device 15 may be fed over a returns pan 17 and a feed pan 18 of a cleaning device 22 comprising (or consisting of) a plurality of sieve planes 19, 20 and a blower 21. The cleaned flow of grains 25 may then be transferred using elevators 23 to a grain tank 24.

In the rear region of the separating device 15, a shredding device 28, which may be designed as a straw chopper 27 and surrounded by a funnel-shaped housing 26, is associated with the separating device 15. The straw 30 leaving the separating device 15 in the rear region is fed to the straw chopper 27 at the top. Using a pivotable straw guide flap 29, the straw 30 may also be deflected in such a way that it is deposited directly on the ground 31 in a swath.

In the outlet area of the straw chopper 27, the flow of harvested material comprising (or consisting of) the chopped straw 30 and the non-grain components separated in the cleaning device 22 may be transferred to a crop distribution device 32, which may discharge the residual material stream 33 in such a way that a wide distribution of the residual material stream 33 occurs on the ground 31.

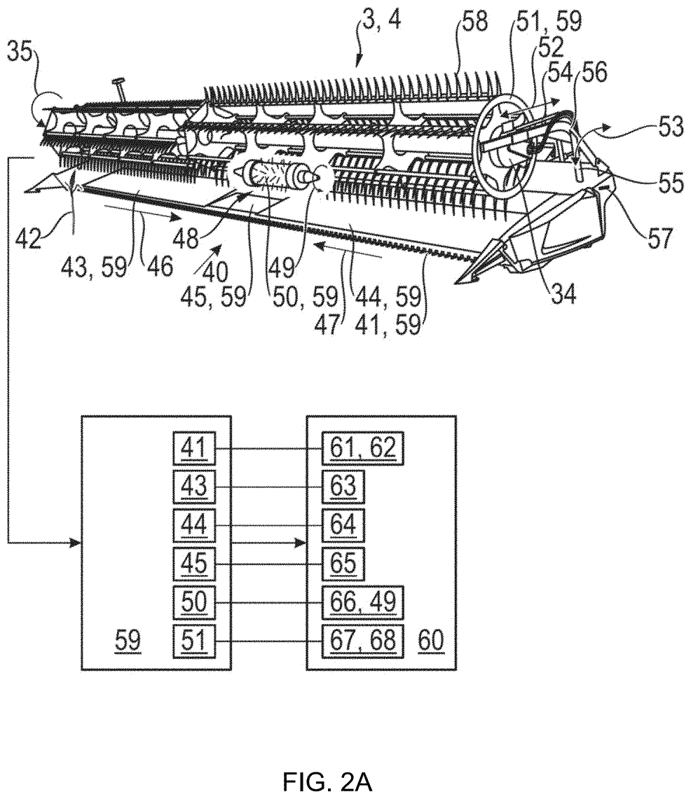

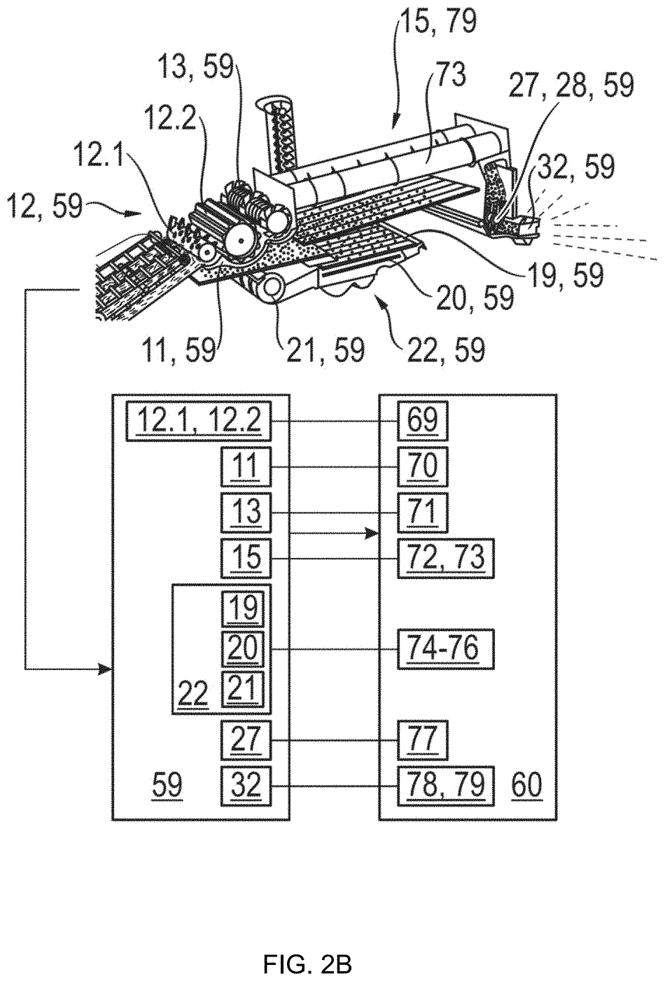

FIG. 2A illustrates details of the harvesting header 3, designed by way of example as a draper 4, and of the agricultural production machine 1 designed as a combine 2, which are necessary for a more detailed explanation of the invention described below. In the harvested material input area 40, the draper 4 may accommodate a cutter bar 41 of either rigid or flexible design, which may cut off the crop 42 to be harvested. A flexibly designed cutter bar 41 may better follow changes in the ground contour in the longitudinal and transverse direction in a known manner. In the depicted embodiment, a left side transverse conveyor belt 43, a right side transverse conveyor belt 44 and a central belt 45 are associated with the cutter bar 41 as viewed in the direction of arrow 40. The left side transverse conveyor belt 43 conveys the harvested material 42, which it has picked up, in the direction of arrow 46 in the direction of the central belt 45 and transfers it thereto. Similarly, the right side transverse conveyor belt 44 conveys the harvested crop 42 that it has picked up in the direction of arrow 47 in the direction of the central belt 45, and transfers it thereto. The central belt 45 then conveys the crop 42 which it has picked up and which has been transferred to the central belt 45 by the transverse conveyor belts 43, 44 into the rear region of the draper 4 in the direction of the arrow 48. In this rear region, the crop 42 is detected by a feed roller 50 which is associated with this region and rotates in the direction of arrow 49, and is transferred to the inclined conveyor 5 as the aforementioned flow of harvested material 10. On the upper side, the draper 4 receives a reel 51 designed in one or more parts. The position of the reel 51 may be adjusted horizontally in a manner known per se in the direction of arrow 52 and vertically in the direction of arrow 53; in the simplest case, lifting cylinders 54, 55 may be positioned on the reel support arm 56 and on the frame 57 of the draper 4 for executing these movements 52, 53. The lifting cylinders 54, 55 may be arranged on both sides of the draper 4. Moreover, the position of the driving tines 58 of the reel 51 may be adjustable in a manner known to one of skill in the art and therefore will not be explained in detail. In addition, a reel drive motor 34 may be associated with the reel 51 at least on one side, which sets the reel 51 in rotary motion in the direction of arrow 35. The cutter bar 41, the left side and right side transverse conveyor belts 43, 44, the central belt 45, the feed roller 50 and the reel 51 may form the particular process units 59 of the draper 4. If the harvesting header 3 is not designed as a draper 4, the process units 59 may also be any other assemblies of a harvesting header 3, such as the assemblies of a conventional grain cutting unit or the like. Each of these process units 59 may be associated with operating parameters 60, wherein the operating parameter of the cutter bar 41, the cutting speed 61 and/or the cutter stroke 62, the operating parameter of the left side transverse conveyor belt 43, the right side transverse conveyor belt 44 and the central belt 45 is the particular belt speed 63-65, the operating parameter of the feed roller 50 is the feed roller horizontal position 66 and/or the feed roller speed 49, and the operating parameter of the reel 51 is the reel vertical position 67 and/or the reel horizontal position 68.

The process units 59 of the agricultural production machine 1 (interchangeably termed an agricultural working machine, an agricultural harvesting machine, or an agricultural harvester) designed as a combine 2 are shown in FIG. 2B. The process units 59 of the combine 2 may comprise, inter alia, the threshing units 12, the threshing concave 11, the deflection roller 13, the separating device 15, the cleaning device 22 and, in this case, especially the sieve planes 19, 20 and the blower 21 associated with the cleaning device 22, the shredding device 28, in this case the straw chopper 27 and the crop distribution device 32. Moreover, the operating parameters 60 of these process units may be the following: the threshing units 12 may be formed by a plurality of threshing drums 12.1, 12.2, and the operating parameter 60 may depict the particular threshing drum speed 69. The operating parameter of the threshing concave 11 may be, for example, its so-called threshing gap width 70. The operating parameter of the deflection roller 13 associated with the threshing units 12 may be its speed 71. Depending on the specific design of the separating device 15, its operating parameters 60 may be entirely different in nature. From the prior art, the particular rotor speed 72 or the opening widths 73 of the separating jacket of the separating device 15, which are not shown here, are known in this case, for example. The operating parameters of the cleaning device 22 may comprise the vibration frequency and vibration direction 74, 75 of the sieve planes 19, 20 and the rotational speed 76 of the blower 21. The operating parameter 60 of the straw chopper 27 may, for example, be limited to the speed 77 of the chopper shaft, which is not shown in detail here. The operating parameters 60 of the crop distribution device 32 may be, in a manner known to one of skill in the art and therefore not described in detail here, the speed 78 of the ejection units (not shown in detail) and the discharge point 79 of the residual material stream 33 from the crop distribution device 32.

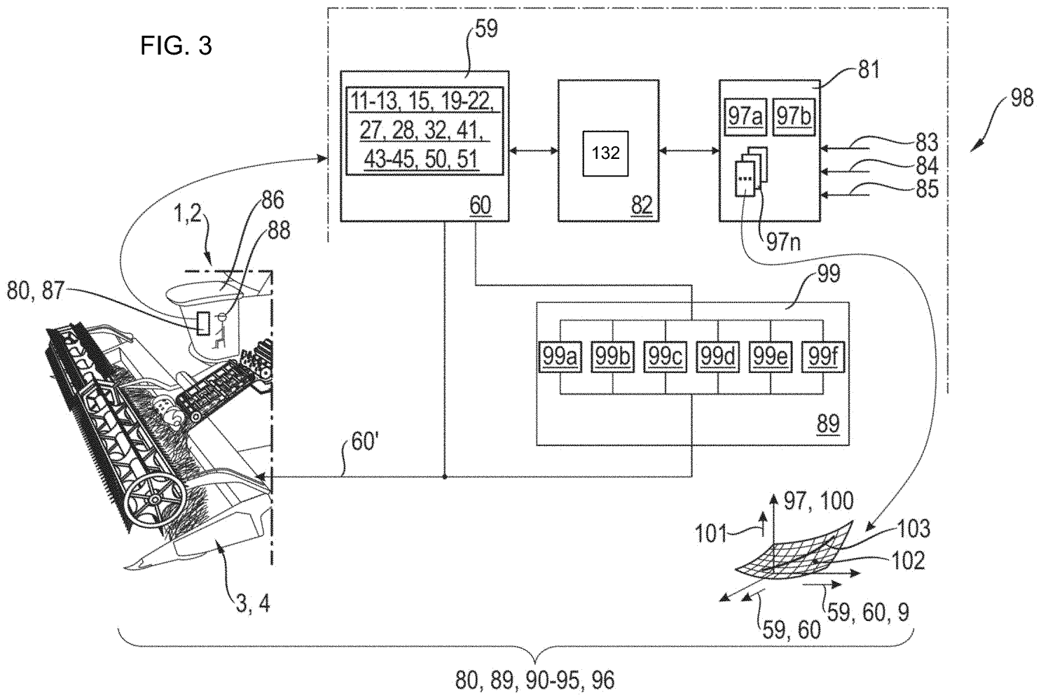

According to FIG. 3, the agricultural production machine 1 has a driver assistance system 80 for controlling the harvesting header 3 and the combine 2. The driver assistance system 80 comprises a memory 81 for saving data, to be explained in more detail, and a computing device 82 for processing the data saved in the memory 81.

The computing device 82 may include any type of computing functionality, such as at least one processor 132 (which may comprise a microprocessor, controller, PLA, or the like) and at least one memory (such as memory 81 or a separate memory). The memory may comprise any type of storage device (e.g., any type of memory). Though the processor 132 and the memory 81 are depicted as separate elements, they may be part of a single machine, which includes a microprocessor (or other type of controller) and a memory. Alternatively, the processor 132 may rely on memory 81 for all of its memory needs.

The processor 132 and memory are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples. Further, the functionality discussed herein, such as the determination of the parameters, using the characteristic diagrams to determine operating parameter(s), or the actuation of the control (e.g., sending commands to control one or more parts of various devices, such as the draper), may be performed by the computing functionality. In practice, the computing device 82 may send the one or more commands via wired or wireless communication.

The data saved in the memory 81 may initially comprise information 83 generated by internal machine sensor systems, information 84 generated by external systems, and information 85 saved directly in the computing device 82. The driver assistance system 80 may be operated via a control and display unit 87 arranged in the cab 86 of the combine 2. In principle, the driver assistance system 80 may be configured to assist a driver 88 of the combine 2 operate the combine 2.

In one or some embodiments, the harvesting header 3, designed for example as a draper 4, may form an automated draper 89 together with the driver assistance system 80. At the same time, the process units 59 may be combined of the agricultural production machine 1 designed as a combine 2, in this case the threshing units 12 including the threshing concave 11 and the deflection roller 13 in an automated threshing unit 90, the separating device 15 in an automated separating unit 91, the cleaning device 22 and in this case the sieve planes 19, 20 and the blower 21 associated with the cleaning device 22 in an automated cleaning unit 92, the shredding device 28, in this case the straw chopper 27 in an automated chopping unit 93, and the crop distribution device 32 in an automated distribution unit 94. In addition, instead of the very specialized automated draper 89, a general automated attachment 95 may be provided. All of the automated units 89-95 enumerated here may be referred to collectively below as an automated process unit 96 for purposes of simplification.

As disclosed, the automated process unit 96 may be implemented in that characteristic diagrams 97 yet to be described in detail are stored in the memory 81 of the driver assistance system 80, and the computing device 82 may be configured to operate the particular automated process unit 96 as a characteristic diagram control 98 (e.g., the computing device 82 configured to operate the particular automatic process unit 96 is an example of a characteristic diagram control device) using the stored characteristic diagrams 97, and the particular automated process unit 96 may be configured to optimize operating parameters 60 of the process units 59 and to specify the optimized operating parameters 60′ to the particular process unit 59. In this way, the particular automated process unit 96 is configured to optimize the operating parameters 60 of one or more of the described process units 59 and to specify the optimized operating parameters 60′ for the particular process unit 11-13, 15, 19-22, 27,28, 32, 41, 43-45, 50, 51.

In addition, the particular automated process unit 96 may be configured to form process unit-specific automated subunits 99 in such a way that each automated subunit 99 controls, such as optimizes, a selection of process units 59. For example, the automated draper 89 (interchangeably termed an automatic draper) may form one or more automatic transverse conveyor belts 99a, 99b, an automatic central belt 99c, an automatic reel 99d, an automatic cutter bar 99e and/or an automatic infeed roller 99f, and the particular automated subunits 99a, 99b, 99c, 99d, 99e, 99f may be configured to optimize the operating parameters 60 of the transverse conveyor belts 43, 44, the central belt 45, the reel 51, the cutter bar 41 and/or the feed roller 50 of the draper 4, and to specify the optimized operating parameters 60′ to the particular process unit 59 of the draper 4. Analogously, one or more characteristic diagrams 97 may also be assigned to one, some or each automated subunit 99a, 99b, 99c, 99d, 99e, 99f.

In one or some embodiments, the particular characteristic diagram 97 may be designed as an initial characteristic diagram 100, wherein in the initial characteristic diagram 100, at least the relationship between operating parameters 60 of a process unit 59 and quality parameters 101 is described by initial operating points 102, and a control characteristic curve 103 is associated with the particular characteristic diagram 97, whereby the control characteristic curve 103 lies around a minimum or maximum of the particular quality parameter 101. In particular, the control characteristic curve 103 may then lie around a minimum of the particular quality parameter 101 if said quality parameter describes a negative working result of the agricultural production machine 1, such as a grain loss. In contrast, the control characteristics (such as the control characteristic curve 103) may then lie around a maximum of the particular quality parameter 101 when this describes a positive work result of the agricultural production machine 1, such as a degree of grain purity. In a start configuration, the initial characteristic diagram 100 may be stored in the driver assistance system 80 of the agricultural production machine 1 or transferred to it prior to a working mode, wherein the initial characteristic diagram 100 may be updated, such as cyclically updated, during the working mode and stored as a new initial characteristic diagram 100. The characteristic diagram 97 associated with the particular process unit 96 may also take into account a parameter representing the harvested material throughput, such as the layer height 9.

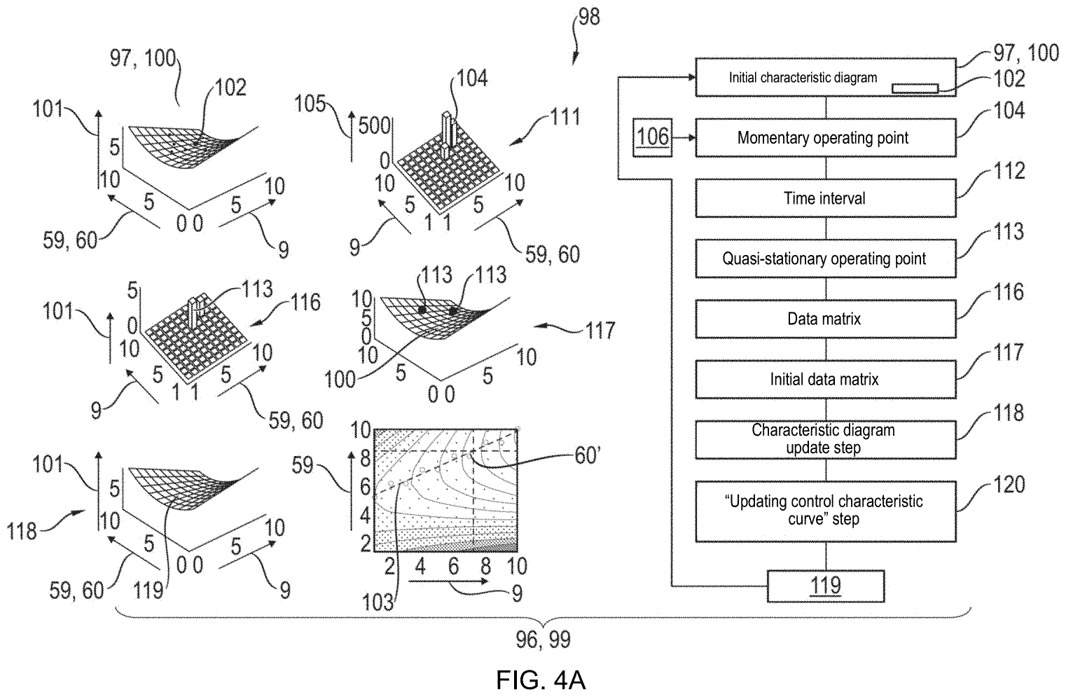

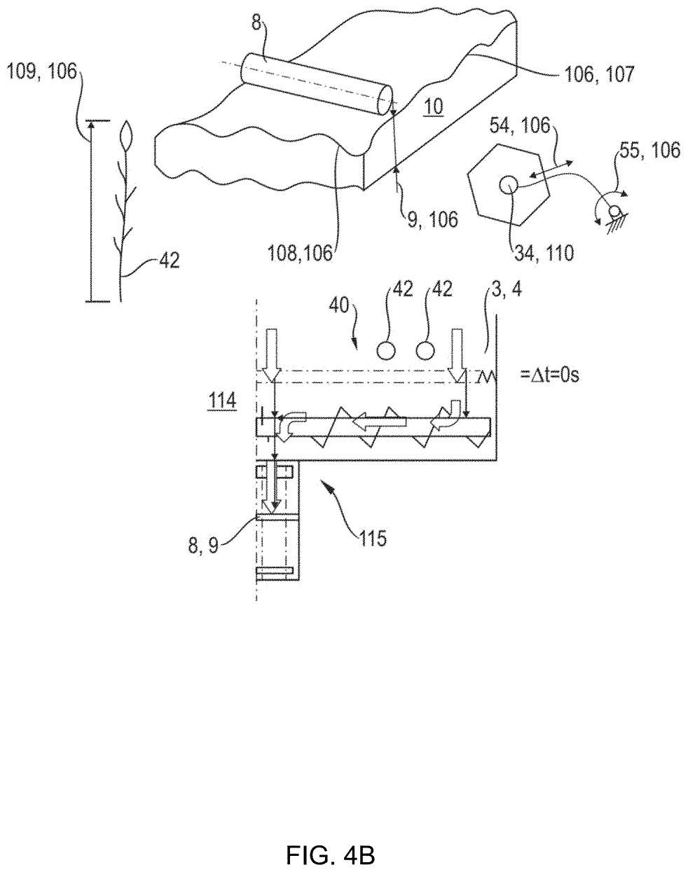

The principle of characteristic diagram generation and characteristic diagram control 98 is described in detail in FIG. 4A. The characteristic diagram 97 may be stored in the particular automated process unit 96 and/or the automated subunit 99 as an initial characteristic diagram 100, wherein the described relationship between operating parameters 60 of the particular process unit 59, quality parameters 101 and the harvested material throughput-related parameter of layer height 9 may be represented in the initial characteristic diagram 100 by initial operating points 102. During harvesting mode of the combine 2, instantaneous operating points 104 may be determined for the layer height 9 and the operating parameters 60 as a function of time 105. In order to determine the instantaneous operating points 104, measurands 106 may be used which, according to FIG. 4B, may be any one, any combination, or all of: a longitudinal vibration 107; a transverse vibration 108 of a flow of harvested material 10 passing through the agricultural production machine 1; a crop height 109 of the crop 42; or a hydraulic pressure 110 or power requirement of a reel drive motor 34. The measurand of longitudinal vibration 107 may correspond to the layer height 9 determined using layer height roller 8 as a function of time, as previously described.

Consequently, the measurands 106 may be such that the quality parameters 101 and layer height 9 proportional to throughput may be derived therefrom.

The determined instantaneous operating points 104 may be temporarily saved in a data matrix 111, wherein the change in the value of the particular instantaneous operating point 104 may be determined within a time interval 112, and the instantaneous operating point 104 may then be transferred to a quasi-stationary operating point 113 if its value remains approximately unchanged (such as constant). An example time interval 112 may be six seconds in this case. In one or some embodiments, the time interval 112 is at least long enough to compensate for a dead time interval 114 in the measurement chain 115. For example, the crop 42 entering the harvesting header designed as a draper 4 in the harvested material infeed side region 40 does not reach the described layer height roller 8 until a certain time has elapsed. This time offset between input of material and measurement of the layer height 9, which depends to a large extent on the working width of the draper 4 and the material conveying speed, may be taken into account during said dead time interval 114 (see FIG. 4B).

The determined quasi-stationary operating points 113 may then be collected in a data matrix 116. If a certain number of quasi-stationary operating points 113 has been collected in the data matrix 116, such as four quasi-stationary operating points 113, the dependencies between quality parameter 101, the throughput-proportional layer height 9 and the operating parameter 60 of the particular process unit 59, may be determined in this data matrix 116 for the collected quasi-stationary operating points 113 analogous to the particular initial characteristic diagram 100. In a next step, the quasi-stationary operating points 113 may be transferred to an initial data matrix 117 which corresponds to the initial characteristic diagram 100 with transferred quasi-stationary operating points 113. Then, in a characteristic diagram update step 118, the updated characteristic diagram 119 may be calculated, which may replace at least a part (or all) of the initial characteristic diagram 100. For the updated characteristic diagram 119 to also enable the described characteristic diagram control 98, as a result of which the automated process unit 96 and/or the automated subunits 99 generate optimized operating parameters 60′, the control characteristic curve 103 may be recalculated for each updated characteristic diagram 119 in a step of “updating control characteristic curve” 120, which control characteristic curve 120 extends in each updated characteristic diagram 119 along the minimum or maximum of the particular quality parameter 101 and describes each optimal operating parameter 60′.

Each updated characteristic diagram 119 may then again form the particular initial characteristic diagram 100 for a subsequent characteristic diagram adaptation process in the particular automated process unit 96 and/or the particular automated subunit 99.

In one or some embodiments, instantaneous operating points 104 may be determined in this way in operating mode as a function of the described measurands 106, which may be converted into quasi-stationary operating points 113, and the determined quasi-stationary operating points 113 may overwrite the corresponding operating points 102 of the particular characteristic diagram 97, wherein part (or all) of the initial characteristic diagram 100 may be converted into an updated characteristic diagram 119, and an updated control characteristic curve 103 of the updated characteristic diagram 119 may be determined.

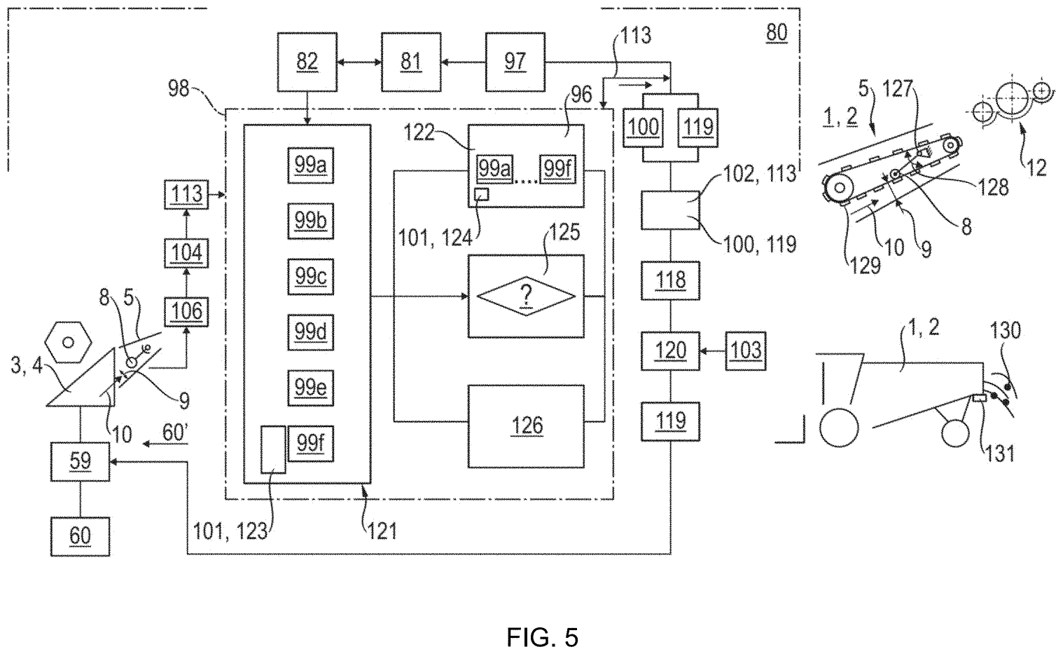

Finally, FIG. 5 describes the driver assistance system 80 according to one aspect of the invention in context. According to the preceding embodiments, the process unit(s) 59 together with the driver assistance system 80 may form an automated process unit 96 which may at the same time comprise automated subunits 99a, 99b, 99c, 99d, 99e, 99f.

By storing characteristic diagrams 97 in the memory 81 of the driver assistance system 80 and by setting up the computing device 82 to operate the automated process unit 96 and/or the automated subunits 99a, 99b, 99c, 99d, 99e, 99f as the characteristic diagram control 98 by means of the stored characteristic diagrams 97, the automated process unit 96 and/or the automated subunits 99a, 99b, 99c, 99d, 99e, 99f may be able to optimize operating parameters 60 of the process units 59 of the harvesting header 3 and of the agricultural production machine 1 designed as a combine 2, and to specify the optimized operating parameters 60′ to the particular process units 59. For this purpose, in a first step, the driver assistance system 80 may determine the described measured variables (such as the measurands 106) of the harvesting header 3 and of the agricultural production machine 1. At least from the determined measurands 106, the driver assistance system 80 according to one aspect of the invention then generates the instantaneous operating points 104 of the automated process units 96 and/or of the automated subunits 99a, 99b, 99c, 99d, 99e, 99f. In a next data processing step, the driver assistance system 80 may convert the instantaneous operating points 104 into quasi-stationary operating points 113 in the manner described above, and then may transmit these quasi-stationary operating points 113 to the automated process unit 96 and/or the automated subunits 99a, 99b, 99c, 99d, 99e, 99f. The characteristic diagram control 98 implemented by the automated process units 96 and/or the automated subunits 99a, 99b, 99c, 99d, 99e, 99f is such that the quasi-stationary operating points 113 may be transferred to the already described particular initial characteristic diagram 100 or already updated the characteristic diagram 119. In the particular characteristic diagram 100, 119, the initial operating point 102 saved therein may then be replaced by the quasi-stationary operating point 113. As described, a number of quasi-stationary operating points 113 may first be transferred to the particular characteristic diagram 100, 119, wherein each of these quasi-stationary operating points 113 may replace an initial operating point 102. Then a characteristic diagram update step 118 may be started, which may result in the particular characteristic diagram 100, 119 being recalculated on the basis of the determined quasi-stationary operating points 113. In the subsequent process step of “updating control characteristic curve” 120, a new control characteristic curve 103 of the particular characteristic diagram 100, 119 may be determined, and ultimately the characteristic diagram 100, 119 and associated control characteristic curve 103 may be redetermined in this way from the particular updated characteristic diagram 119. The driver assistance system 80 may then use the updated characteristic diagram 119 to determine the particular optimized operating parameters 60′, which has already been described, and may specify them to the particular process unit 59.

The characteristic diagram control 98 of the automated process units 96 and/or of the semi-automatic units 99a, 99b, 99c, 99d, 99e, 99f may also be such that it permits a fast, a dynamic characteristic diagram adaptation 121 and a sluggish characteristic diagram adaptation 122. A dynamic characteristic diagram adaptation 121 may be achieved when the quality parameter 101 of the particular characteristic diagram 97 is formed by a vibration coefficient 123, to be described in greater detail. The vibration coefficient 123 known to one of skill in the art is described in detail in US Patent Application Publication No. 2021/0235622 A1, incorporated by reference herein in its entirety. According to the disclosure of US Patent Application Publication No. 2021/0235622 A1, the vibration coefficient 123 describes a fluctuation of the harvested material throughput passing through the combine 2. For this purpose, the layer height 9 of the flow of harvested material 10 passing through the combine 2 in the region of the inclined conveyor 5 may be recorded as a function of time. The determined layer height fluctuation may then be converted into the vibration coefficient 123 according to the method disclosed in US Patent Application Publication No. 2021/0235622 A1. The layer height 9 may be determined in a region located upstream of the threshing units 12 since the flow of harvested material 10 may be processed so intensively in the region of the threshing units 12 that layer height fluctuations in the flow of harvested material 10 after leaving the threshing units 12 no longer have a sufficient relationship to the harvested material throughput. The layer height 9 may be determined using the aforementioned layer height roller 8 in the region of the inclined conveyor 5, wherein the layer height roller 8 may be guided so as to be pivotable about a pivot axis 127, and the deflection 128 of the layer height roller 8 may be used as a measure for determining the layer height 9. In a manner known to one of skill in the art, the layer height roller 8 may be positioned above the inclined conveyor strips 129, which may affect the entrainment of the material, in such a way that their layer-height-dependent movement is transmitted to the layer height roller 8 and effects the deflection 128 of the layer height roller 8.

The quality parameter “vibration coefficient 123” therefore may permit fast, dynamic characteristic diagram adaptation 121, since this quality parameter 101 depends on the layer height 9 detected in the layer height roller 8 positioned in the inclined conveyor 5 and is determined immediately directly after the flow of harvested material 10 enters the agricultural production machine 1.

In contrast, the sluggish characteristic diagram adaptation 122 may be established by the fact that the quality parameter 101 of the particular characteristic diagram 97 may be formed by a separation loss 124 and this may only be measured when the residual material stream 33 and the loss grains contained therein leave the agricultural production machine 1 in the rear region thereof. The separation loss 124 may describe the grain loss 130, namely the loss grain portion exiting the combine 2 in its rear region. As a rule, the grain loss 130 in the rear region of the combine 2 may be determined in a manner known to one of skill in the art using suitable and sufficiently known grain loss sensors 131, as a rule so-called knock sensors.

Although generated at a late point in time, the sluggish characteristic diagram adaptation 122 has the advantage that it detects a parameter, in this case the separation loss 124, which may decisively determine the working quality of the agricultural production machine 1, and high separation losses 124 may always also be an indicator of a non-optimal flow of harvested material in the agricultural production machine 1, wherein a non-optimal flow of harvested material in the agricultural production machine 1 may be counteracted in particular if the harvesting header 3 produces a homogeneous flow of harvested material 10 which may then be continuously transferred to the agricultural production machine 1.

In addition, the driver assistance system 80 may be such that the characteristic diagram control 98 comprises a test step 125 in which it is tested whether opposing tendencies for the value of the particular optimized operating parameter 60′ occur for the operating parameters 60 to be optimized when the dynamic characteristic diagram adaptation 121 and the sluggish characteristic diagram adaptation 122 are applied. If this is the case, boundary conditions may be used to decide which operating point resulting from the control characteristic curve 103 is approached. In one or some embodiments, the mentioned boundary conditions may be saved in a cost function which may consider the parameters throughput/h, vibration coefficient 123, separation loss 124, cutting unit loss, wherein these parameters may be weighted differently.

Further, the driver assistance system 80 may take expert knowledge 126 into account when generating the particular characteristic diagrams 97, which may be both the initial characteristic diagrams 100 and the updated characteristic diagrams 119.

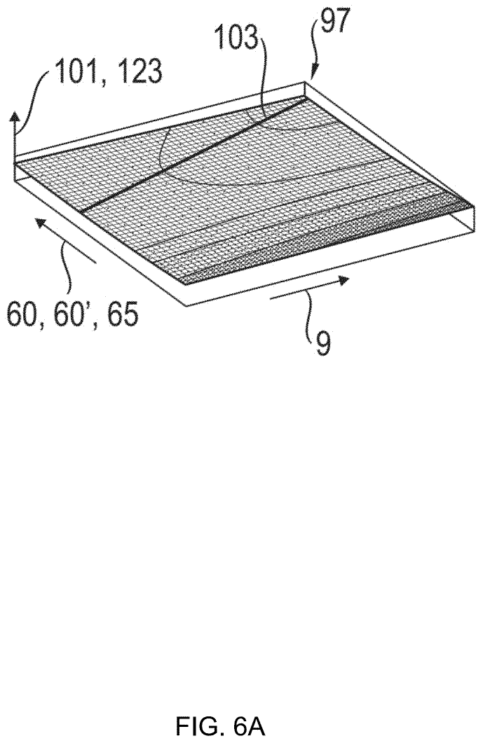

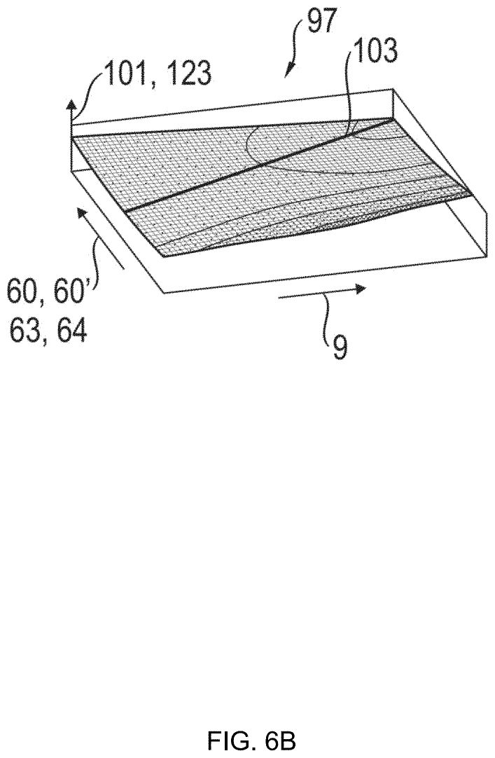

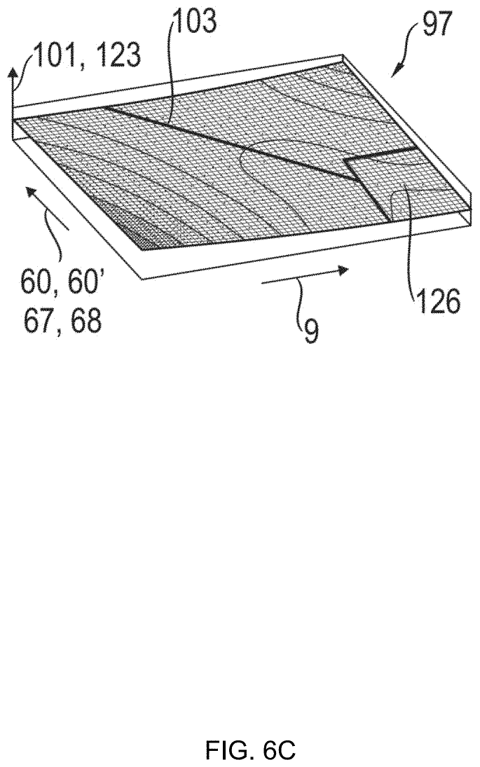

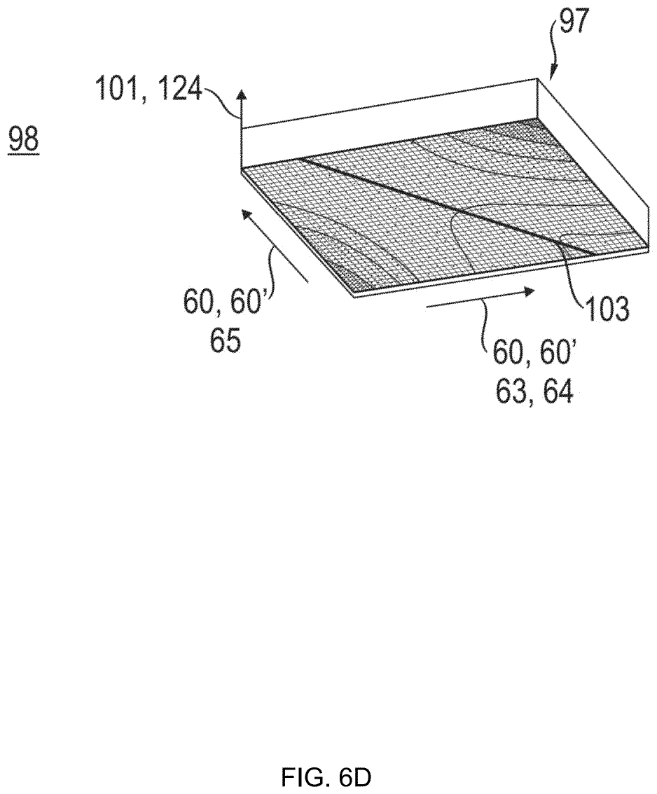

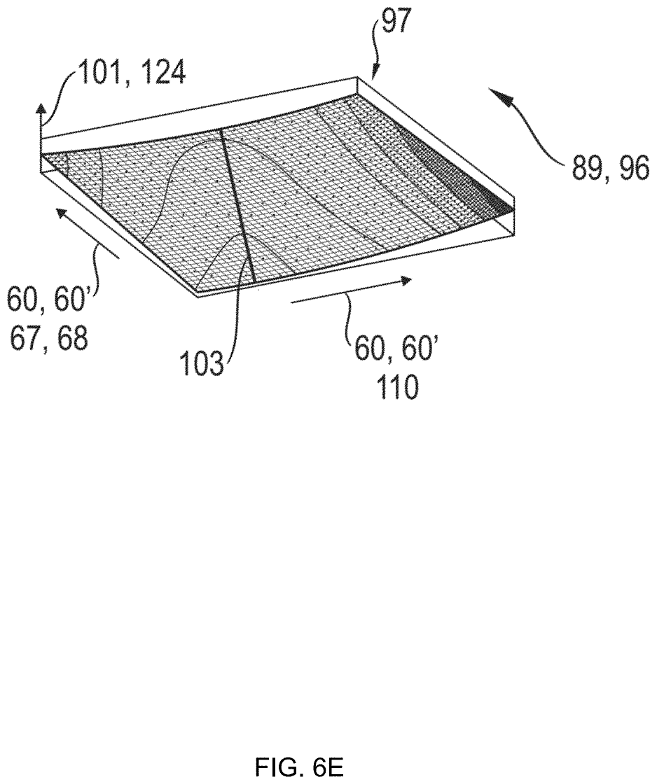

In FIGS. 6A-E, the use of the method as disclosed for the adaptation of characteristic diagrams 97 is described in more detail using the example of the automated draper 89. In FIGS. 6A-E, the characteristic diagrams 97 may be described as a function of various quality parameters 101, wherein the described vibration coefficient 123 and the separation loss 124 are used here as quality parameters 101. It is within the scope of the invention that, depending on the specific automated process unit 96, other quality parameters 101 known in the prior art may also be used to apply the method as disclosed herein. By way of example, reference may be made to the known quality parameters 101 “cleaning loss”, “composition of a reverse stream of harvested material”, of broken grain fraction, separation losses, non-grain components in the bin, and straw quality.

The characteristic diagrams 97 saved in the automated draper 89 and/or its automated subunits 99 may be structured quite differently depending on which type of optimization is to be implemented. According to FIGS. 6A-C, the particular characteristic diagram 97 may describe the particular operating parameter 60 as a function of the vibration coefficient 123 and the harvested material throughput by the layer height 9 representing the harvested material throughput. According to FIG. 6D-E, the particular characteristic diagram 97 may describe the particular operating parameter or parameters 60 at least as a function of the separation loss 124.

For the particular characteristic diagram 97 to enable the described characteristic diagram control 98, as a result of which the automated draper 89 and/or the automated subunits 99 generate optimized operating parameters 60′, each characteristic diagram 97 may be assigned the control characteristic curve 103 which extends here in the particular characteristic diagram 97 along the minimum of the particular vibration coefficient 123 or the separation loss 124 and describes the particular optimal operating parameter 60′.

In one embodiment according to FIG. 6A, the characteristic diagram 97 describes the relationship between the quality parameter vibration coefficient 123, the parameter layer height 9 representing the harvested material throughput, and the operating parameter 60 middle conveyor belt speed 65, wherein and the control characteristic curve 103 assigned to the characteristic diagram 97 lies around the minimum vibration coefficient 123. As a tendency, it may be seen that the characteristic diagram control 98 here is such that greater layer heights 9 require higher belt speeds 65, while belt speeds 65 which are too high or too low tend to have a negative influence on the vibration coefficient 123 and thus on an optimized operating parameter 60′. In this regard, using the characteristic diagram 97 illustrated in FIG. 6A and using a value may be input for the parameter layer height may generate an output value for the middle conveyer belt speed 65 (e.g., based on the input of the parameter layer height 9 and the control characteristic curve 103, which may seek to reduce or minimize vibration (as indicated by the control characteristic curve lying around the minimum vibration coefficient), a value for the middle conveyer belt speed 65 may be determined to reduce or minimize the vibration; in turn, the value for the middle conveyer belt speed 65 may be sent to the draper 4 for automatic execution).

In one embodiment according to FIG. 6B, the characteristic diagram 97 describes the relationship between the quality parameter vibration coefficient 123, the parameter layer height 9 representing the harvested material throughput, and the operating parameter 60 “belt speed of the right side/left side transverse conveyor belt” 63, 64, wherein and the control characteristic curve 103 assigned to the characteristic diagram 97 lies around the minimum vibration coefficient 123. As a tendency, it may be seen that the characteristic diagram control 98 here is such similar to FIG. 6A, wherein the particular influences that greater layer heights 9 require higher belt speeds 63, 64, while belt speeds 63, 64 which are too high or too low tend to have a negative influence on the vibration coefficient 123 and thus on an optimized operating parameter 60′, are more pronounced. Thus, similar to the discussion above, the control characteristic curve 103 assigned to the characteristic diagram 97 in combination with the layer height 9 may be used to determine values for one or both of the belt speeds 63, 64 in order to reduce or minimize vibration.

In an embodiment according to FIG. 6C, the characteristic diagram 97 describes the relationship between the quality parameter of vibration coefficient 123, the parameter of layer height 9 representing the harvested material throughput, and the operating parameter 60 “reel horizontal position and/or reel vertical position” 67, 68, wherein the control characteristic curve 103 associated with the characteristic diagram 97 lies around the minimum of the vibration coefficient 123. It may be seen that the characteristic diagram control 98 here does not follow a distinct tendency, but depends very specifically on the parameters related to each other. Due to the fact that a change in position 67, 68 of the reel 51 follows very complex relationships, the control characteristic curve 103 in this case does not extend through all areas of the characteristic diagram 97, but is replaced by expert knowledge 126 in specific edge areas the control characteristic curve 103. Thus, similar to the discussion above, the control characteristic curve 103 assigned to the characteristic diagram 97 in combination with the layer height 9 may be used to determine values for one or both of “reel horizontal position and/or reel vertical position” 67, 68 in order to reduce or minimize vibration.

In an embodiment according to FIG. 6D, the characteristic diagram 97 describes the relationship between the quality parameter of separation loss 124 and the operating parameters 60 “central belt speed” 65 and “belt speed of the left side and/or right side transverse conveyor belt” 63, 64, wherein the control characteristic curve 103 associated with the characteristic diagram 97 lies around the minimum of the separation loss 124. Generally, the influence of the belt speeds 63-65 on the separation loss 124 is moderate, and basically, all the belt speeds 63-65 have the same tendency, namely that if the belt speed 63, 64 of the left side and/or right side transverse conveyor belts 43, 44 increases or decreases, the optimized belt speed 65 of the central belt 45 may also increase or decrease and vice-versa. Thus, FIG. 6D may be used to reduce or minimize a different quality parameter (separation loss 124) than used in FIG. 6A. Nevertheless, the output (e.g., selecting a value for the middle conveyer belt speed 65) is the same. Thus, a first quality parameter (vibration coefficient 123) is the focus of FIG. 6A whereas a second quality parameter (separation loss 124) is the focus of FIG. 6D. In one or some embodiments, multiple quality parameters may be the focus of a respective characteristic diagram 97, such as both a first quality parameter (vibration coefficient 123) and a second quality parameter (separation loss 124).

In an embodiment according to FIG. 6E, the characteristic diagram 97 describes the relationship between the quality parameter of separation loss 124, the parameter “hydraulic pressure or power requirement of a reel drive motor/reel drive cylinder” 110 representing the harvested material throughput, and the operating parameter 60 “reel horizontal position and/or reel vertical position” 67, 68, wherein the control characteristic curve 103 associated with the characteristic diagram 97 lies around the minimum separation loss 124. It may be generally seen that, with increasing hydraulic pressure 110, e.g., with increasing throughput or a crop 42 that has grown taller, a greater reel height 67, 68 may lead to lower separation losses 124.

Since the separation loss 124 is only determined when the corresponding flow of harvested material 10 has completely passed through the combine 2, and the harvested material throughput which depends on the detected layer height 9 may be determined immediately after the flow of harvested material 10 has entered the combine 2, the adaptation of the particular characteristic diagram 97 as a function of the vibration coefficient 123 may result in a rapid adaptation of the particular characteristic diagram 97, whereas the adaptation of the particular characteristic diagram 97 as a function of the separation loss 124 may result in a slower adaptation of the particular characteristic diagram 97. In this regard, responsive to determining certain aspects (e.g., vibration coefficient 123), the adaptation of the particular characteristic diagram 97 may be performed more quickly than responsive to determining other aspects (e.g., separation loss 124).

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Agricultural work machine
2 Combine
3 Harvesting header
4 Draper
5 Inclined conveyor
6 Conveying elements
7 Pivot axis
8 Layer height roller
9 Layer height
10 Harvested material flow
11 Threshing concave
12 Threshing unit
13 Deflection drum
14 Separating rotor assembly
15 Separating device
16 Grains
17 Returns pan
18 Feed pan
19 Screening level
20 Screening level
21 Fan
22 Cleaning device
23 Elevator
24 Grain tank
25 Grain flow
26 housing
27 Straw chopper
28 Shredding device
29 Separating rotor assembly
30 Straw
31 Ground
32 Crop distribution device
33 Residual material flow
40 Harvested material infeed side region
41 Cutter bar
42 Plant crop
43 Left side transverse conveyor belt
44 Right side transverse conveyor belt
45 Central belt
46-49 Arrow direction
50 Feed roller
51 Reel
52, 53 Arrow direction
54, 55 Pressure cylinder
56 Separating rotor assembly
57 Frame
58 Driving tines
59 Driving tines
60 Operating parameter
60′ Optimized operating parameter
61 Cutting speed
62 Cutter stroke
63-65 Belt speed
66 Feed roller horizontal position
67 Reel vertical position
68 Reel horizontal position
69 Threshing drum speed
70 Threshing gap
71 Deflection drum speed
72 Rotor speed
73 Opening width of the separating jacket
74 Vibration frequency and direction
75 Vibration frequency and direction
76 Fan speed
77 Straw chopper speed
78 Distribution device speed
79 Distribution device discharge point
80 Driver assistance system
81 Memory
82 Computer device
83 Internal information
84 External information
85 Saved information
86 Cabin
88 Driver
89 Automated draper
90 Automated threshing unit
91 Automated separating unit
92 Automated cleaning unit
93 Automated chopping unit
94 Automated distribution unit
95 Automated attachment
96 Automated process unit
97 Characteristic diagram
98 Characteristic diagram control
99 Automated subunit
100 Initial characteristic diagram
101 Quality parameter
102 Initial operating point
103 Control characteristics
104 Momentary operating point
105 Time
106 Measurand
107 Longitudinal vibration
108 Transverse vibration
109 Crop height
110 Hydraulic pressure
111 Data matrix
112 Time interval
113 Quasi-stationary operating point
114 Dead time interval
115 Measuring chain
116 Data matrix
117 Initial data matrix
118 Characteristic diagram update step
119 Updated characteristic diagram
120 “Updating control characteristic curve” step
121 Dynamic characteristic diagram adaptation
122 Sluggish characteristic diagram adaptation
123 Vibration coefficient
124 Separation loss
125 Test step
126 Expert knowledge
127 Pivot axis
128 Deflection
129 Inclined conveyor strips
130 Grain loss
131 Grain loss sensor
132 Processor

1. An agricultural production machine comprising:
a characteristic diagram control device, wherein the characteristic diagram control device comprises at least one controller and at least one memory;
wherein the at least one memory is configured to store at least one characteristic diagram used by the at least one controller for selecting one or more operating parameters of at least one process unit of the agricultural production machine;
wherein at least one characteristic diagram is designed as an initial characteristic diagram;
wherein in the initial characteristic diagram, initial operating points describe at least a relationship between operating parameters of the at least one process unit and one or more quality parameters;
wherein a control characteristic curve is associated with the at least one characteristic diagram;
wherein the control characteristic curve is positioned relative to a minimum or a maximum of at least one of the one or more quality parameters; and
wherein the at least one controller, using the at least one characteristic diagram, is configured to select the one or more operating parameters of the at least one process unit of the agricultural production machine.

2. The agricultural production machine of claim 1, wherein the control characteristic curve lies around the minimum or maximum of the at least one of the one or more quality parameters; and
wherein the at least one controller is configured to:
determine instantaneous operating points in a working mode as a function of measurands;
convert the instantaneous operating points into quasi-stationary operating points;
overwrite one or more of the initial operating points or previously updated operating points of the at least one characteristic diagram;
convert at least a part of the initial characteristic diagram into an updated characteristic diagram; and
determine an updated control characteristic curve of the updated characteristic diagram.

3. The agricultural production machine of claim 2, wherein the at least one controller is configured to determine optimized operating parameters using the updated control characteristic curve; and
wherein the optimized operating parameters are specified to the at least one process unit.

4. The agricultural production machine of claim 2, wherein the at least one controller is configured to:
temporarily save the instantaneous operating points in a first data matrix;
determine a change in a value of a respective instantaneous operating point; and
responsive to determining that the value of a respective instantaneous operating point is unchanged, transfer the respective instantaneous operating point to a quasi-stationary operating point.

5. The agricultural production machine of claim 4, wherein the at least one controller is configured to collect the quasi-stationary operating points in a further data matrix;
wherein responsive to collecting a predetermined number of quasi-stationary operating points in the further data matrix, determine dependencies between at least one quality parameter and at least one operating parameter in the further data matrix for the quasi-stationary operating points analogous to the initial characteristic diagram.

6. The agricultural production machine of claim 5, wherein the at least one controller is configured to transfer the quasi-stationary operating points collected in the further data matrix to an initial data matrix; and
wherein the initial data matrix corresponds to the initial characteristic diagram with the quasi-stationary operating points transferred therein.

7. The agricultural production machine of claim 6, wherein the at least one controller, in a characteristic diagram update step, is configured to calculate an updated characteristic diagram from the initial data matrix;
wherein the at least one controller is configured to replace the initial characteristic diagram or a previously updated characteristic diagram with the updated characteristic diagram; and
wherein the at least one controller is configured, in a control characteristic update step, to recalculate the control characteristic for the updated characteristic diagram.

8. The agricultural production machine of claim 1, wherein the characteristic diagram control device is integrated into a driver assistance system assigned to the agricultural production machine;
wherein the at least one characteristic diagram is stored in a memory of the driver assistance system; and
wherein the at least one controller is configured to use the at least one characteristic diagram; and
wherein the driver assistance system is further configured to:
determine measurands;
derive at least one instantaneous operating point from the measurands;
convert at least one instantaneous operating point into at least one quasi-stationary operating point;
transfer the at least one quasi-stationary operating point to the initial characteristic diagram or to an already-updated characteristic diagram;
replace an initial operating point or an already-updated operating point in the initial characteristic diagram with the at least one quasi-stationary operating point;
calculate an updated characteristic diagram using the at least one quasi-stationary operating point;
determine a control characteristic of the updated characteristic diagram;
determine one or more operating parameters using an updated control characteristic curve of the updated characteristic diagram; and
specify at least one of the one or more operating parameters to the at least one process unit.

9. The agricultural production machine of claim 8, wherein at least one controller is configured to cyclically update the initial characteristic diagram as a new initial characteristic diagram during a working mode of the agricultural production machine.

10. The agricultural production machine of claim 8, wherein the measurands comprise one or more of: longitudinal vibration or transverse vibration of a flow of harvested material passing through the agricultural production machine; crop height; or hydraulic pressure or power requirement of a reel drive motor; and
wherein the driver assistance system is configured to convert the measurands into the one or more quality parameters or a harvested material throughput.

11. The agricultural production machine of claim 8, wherein the at least one process unit together with the driver assistance system form an automated process unit in that the at least one characteristic diagram is stored in the memory of the driver assistance system;
wherein the at least one controller is configured to operate the automated process unit using the at least one characteristic diagrams stored in the memory; and
wherein the automated process unit is configured to optimize the one or more operating parameters of the at least one process unit and to specify the one or more operating parameters that are optimized to the at least one process unit.

12. The agricultural production machine of claim 11, wherein the automated process unit is configured as one or more of an automated attachment, an automated draper, an automated threshing unit, an automated separating unit, an automated cleaning unit, an automated chopping unit, or an automated distributing unit;
wherein the automated process unit comprises at least one automated subunit;
wherein the at least one automated subunit is configured to optimize the one or more operating parameters of the at least one process unit and to specify the one or more operating parameters that are optimized to the at least one process unit.

13. The agricultural production machine of claim 1, wherein the one or more quality parameters of the at least one characteristic diagram comprise one or both of a vibration coefficient or a separation loss.

14. The agricultural production machine of claim 13, wherein the vibration coefficient is indicative of a fluctuation of harvested material throughput;
wherein the agricultural production machine is configured to determine the harvested material throughput and the vibration coefficient indicative of fluctuation in the harvested material throughput in a region lying in front of one or more threshing units of the agricultural production machine; and
wherein the separation loss is indicative of a loss grain portion separated from the agricultural production machine.

15. The agricultural production machine of claim 14, wherein the at least one characteristic diagram is indicative of a particular operating parameter as a function of one or both of:
the vibration coefficient and layer height representing the harvested material throughput; or
the separation loss.

16. The agricultural production machine of claim 15, wherein the at least one characteristic diagram is indicative of a relationship between the vibration coefficient, the layer height representing the harvested material throughput, and an operating parameter; and
wherein the control characteristic curve assigned to the at least one characteristic diagram lies around a minimum vibration coefficient.

17. The agricultural production machine of claim 1, wherein the at least one process unit comprises an automated draper;
wherein the at least one characteristic diagram is dependent on a relationship between two or more of: a vibration coefficient quality parameter, layer height representing harvested material throughput, belt speed of a middle belt operating parameter, belt speed of one or both of right side or left side transverse conveyor belt operating parameter, reel horizontal position operating parameter, or reel vertical position operating parameter; and
wherein the control characteristic curve associated with the at least one characteristic diagram lies around a minimum of a vibration coefficient.

18. The agricultural production machine of claim 1, wherein the at least one process unit comprises a draper
wherein the at least one characteristic diagram is indicative of relationship between at least one of separation loss, hydraulic pressure, or power requirement of one or both of a reel drive motor or reel drive cylinder representing harvested material throughput, and one or both of reel horizontal position or reel vertical position; and
wherein the control characteristic curve associated with the at least one characteristic diagram lies around a minimum separation loss.

19. The agricultural production machine of claim 1, wherein adaptation of the at least one characteristic diagram as a function of vibration coefficient results in a faster dynamic adaptation of the at least one characteristic diagram while the adaptation of the at least one characteristic diagram as a function of separation loss results in a slower adaptation of the at least one characteristic diagram.

20. The agricultural harvesting machine of claim 19, wherein the adaptation of the at least one characteristic diagram comprises a superimposition of the faster dynamic adaptation of the at least one characteristic diagram as a function of the vibration coefficient and the slower adaptation of the at least one characteristic diagram as a function of the separation loss.
